(19) United States
(12) Patent Application Publication
(10) Pub. No.: US 2018/0339580 A1
(43) Pub. Date: Nov. 29, 2018

(54) RETRACTABLE COVER

(71) Applicant: GLENN DAHLBERG, BOULDER, CO (US)

(72) Inventor: GLENN DAHLBERG, BOULDER, CO (US)

(21) Appl. No.: 15/603,469

(22) Filed: May 24, 2017

(51) Int. Cl. B60J 7/12; B60P 3/34; E04H 15/06; E04H 15/34; E04H 15/54

(52) U.S. Cl. CPC B60J 7/123; B60P 3/341; E04H 15/54; E04H 15/34; E04H 15/06

(57) ABSTRACT

The present invention relates to a retractable cover made up of highly flexible material enabled to slide over the plurality of the rods which further is made up of plurality of small sections to make the entire structure of the retractable cover sliding over the easily bendable and flexible plurality of the rods flexible in nature and easy carriable to any distance without occupying much space. The invention support the text for the retractable cover to be easily fitted over any shape or size of the utility trailer without having a concern of length and width of the utility trailer and also without having a concern of plurality of the brackets arrangement structure pattern over the wheeled flat-bed.

### FIELD OF INVENTION

The present invention relates to a retractable cover fastened onto a utility trailer flat bed, to protect cargo carried on the utility trailer, protect different items covered and stored in the utility trailer, like a parked motor cycle or 4-wheeler. The invention also supports providing a handy tent for various recreational activities, like hunting and camping.

### BACKGROUND OF THE INVENTION

Those who have utility trailers find them to be very handy when moving, working on home-improvement projects, construction jobs, and any time there is a need to carry building materials, household goods, and tools for specific jobs. Utility trailers have no covers, making them easy to load high. Unfortunately, once loaded, all the goods are vulnerable to being damaged by wind, rain, snow, and sleet. Even when the load is wrapped in plastic, it may still be damaged as it is hard to secure the plastic well enough to withstand the wind created when the trailer is being pulled down the highway.

The various available products in the market are manufactured with a proper specification and can be utilized only with specific sized or shape utility trailer flat bed for which it is been manufactured. These trailer lacks the novelty of been made of a material which is stretchable in nature and which can be utilized for any shape and size of the utility trailer. Also, the various available utility trailer flat-bed covers present opens pivotally therefore there don't exist a proper air flow inside the utility trailer.

Therefore, there remains a need to overcome above mentioned problems and our invention resolve this entire problem.

### SUMMARY OF THE INVENTION

The present invention relates to a retractable cover fastened onto a utility trailer flat bed, to protect cargo carried on the utility trailer, protect different items covered and stored in the utility trailer, like a parked motor cycle or 4-wheeler. The invention supports providing a handy tent for various recreational activities, like hunting and camping.

The retractable cover herein act as a universal cover to be fitted over the loads to protect the goods or equipment while transporting or storing it from one place to another or to a place respectively. The invention further provides a shelter or tent for the at least one user at the time of his/her tracking or campaign. The unique features of the retractable cover provide the following benefits for the at-least one user who need a way to cover and protect the items when transporting them on a flat-bed utility trailer, wherein the unique features of the retractable cover comprises the feature listed below:
The retractable cover is enabled to be installed on any shape or size utility trailer measuring eight to sixteen feet long.
The retractable cover provides protection from inclement weather for goods while being transported or stored on the utility-trailer.
The retractable cover functions as conventional tent when attached to any shape or sized flat-bed utility trailer for those who want an inexpensive place to sleep when traveling,
The retractable cover always be attached to the utility trailer and is enabled to pulled over cargo easily whenever protection is needed.
The retractable trailer is designed to be aerodynamic when going down the highway,
The retractable cover herein is further manufactured of highly flexible materials like fiber, plastic, PVC polymer, thermoplastics or the combination thereof and therefore enables providing high range of elasticity and stretch-ability to adjust any shape and size of the utility trailer.
Due to the coupling of the retractable cover over the plurality of the rods forming a frame structure to support and slide the retractable cover over it enables providing the retractable cover a feature to drawing or pull back to its same position when not in use of the at least one user and when in the unzipped position.

The invention further provides a highly flexible structure and enables the at least one user to easily access and carry the entire structure to its place of requirement without having problem of space and carriables.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the inner perspective view of a retractable cover according to an embodiment of the invention.

FIG. 2 illustrates the front perspective view of the retractable cover according to an embodiment of the invention.

FIG. 3 illustrates the back view of the retractable cover according to an embodiment of the invention.

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

Unless defined otherwise, all technical terms used herein have the same meaning as commonly understood by one of ordinary skill in the art to which this invention belongs. Although any methods and materials similar or equivalent to those described herein can also be used in the practice or testing of the present invention, the preferred methods and materials are now described.

The present invention relates to a retractable cover which fits over the loads to protect the goods or equipment while transporting or storing it from one place to another or to a place respectively. The invention further provides a shelter or tent for the at least one user at the time of his/her tracking or campaign. The unique features of the retractable cover provide the following benefits for the at-least one user who need a way to cover and protect the items when transporting them on a flat-bed utility trailer, wherein the unique features of the retractable cover comprises the feature listed below:
The retractable cover is designed to be universal and is enabled to be installed on any shape or size utility trailer measuring eight to sixteen feet long,
The retractable cover provides protection from inclement weather for goods while being transported or stored on the utility-trailer,
The retractable cover functions as conventional tent when attached to any shape or sized flat-bed utility trailer for those who want an inexpensive place to sleep when traveling,
The retractable cover always be attached to the utility trailer and is enabled to pulled over cargo easily whenever protection is needed,
The retractable cover is designed to be aerodynamic when going down the highway,
The retractable cover herein is further manufactured of highly flexible materials like fiber, plastic, PVC polymer, thermoplastics or the combination thereof and therefore enables providing high range of elasticity and stretch-ability to adjust any shape and size of the utility trailer, and
Due to the coupling of the retractable cover over the plurality of the rods forming a frame structure to support and slide the retractable cover over it enables providing the retractable cover a feature to drawing or pull back to its same position when not in use of the at least one user and when in the unzipped position.

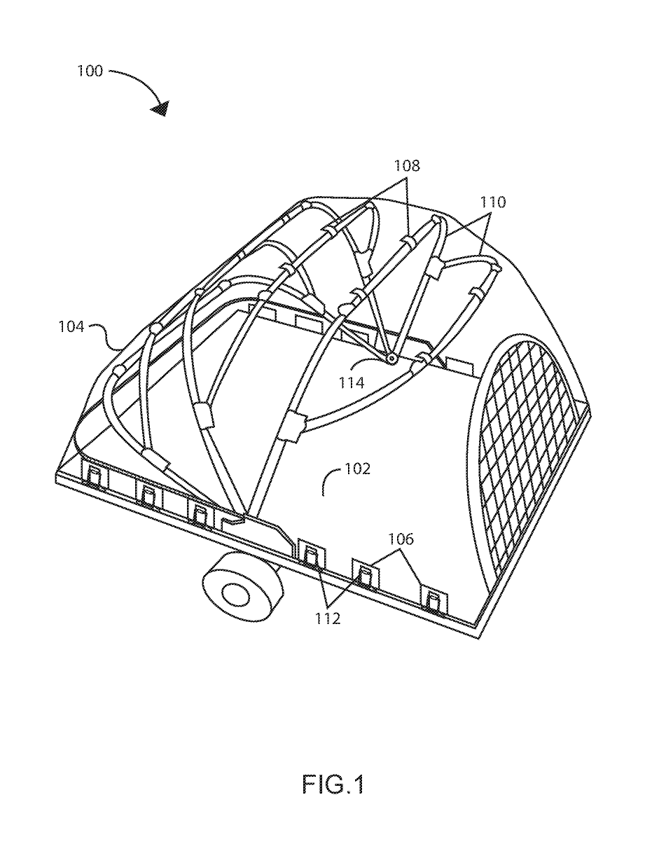

FIG. 1 illustrates the inner perspective view of the present invention of a retractable cover [104] which is coupled to a wheeled flat-bed [102] of the utility trailer[100] and further comprises: a plurality of first coupling member [106], coupled to a perimeter of the retractable cover [104] to provide coupling of the retractable cover [104] with the wheeled flat-bed [102]; a plurality of loops [108] present on an inner surface [not shown] of the retractable cover[104], enables the retractable cover[104] to slide over a plurality of the rods [110], coupled to the wheeled flat-bed [102] and further secure the retractable cover [104] over the plurality of rods [110]. The retractable cover [104] herein is bolted on to a central hinge [114] provided at the either side of the wheeled flat-bed [102] of a utility trailer [100]. Also, the central hinge [114] of the wheeled flat-bed [102] further enables the retractable cover [104] to be folded flat against the wheeled flat-bed [102] when it not in use, and open-up easily to cover any goods on the wheeled flat-bed [102] of the utility trailer [100]. The invention herein supports a highly flexible retractable cover [104] which is made up of a material highly flexible in nature like plastic, fiber, PVC polymer, thermoplastic or the combination thereof. The retractable cover [104] herein is further enabled to get attached to the plurality of rods [110], like ribs, that support the retractable cover [104] to provide the adjustment of the retractable cover [104] over any shape or size of the utility trailer [100] further coupled with the plurality of the rods [110]. Also, the invention supports the plurality of the second coupling member [108] that are present on the inner side of the retractable cover [104] to enable the retractable cover [104] to slide over the plurality of the rods [110] thus securing the retractable cover [104] to cover to the utility trailer [100]. The plurality of the first [106] and the second coupling member [108] is at least one of a Velcro, a hinge, a bolt or the combination thereof. The plurality of the rods [110] to secure the retractable cover [104] is also highly flexible and bendable in nature and is made up of plurality of small section hingably coupled to each other via hinge [not shown]. The plurality of the rods [110] herein is enabled to be bent from any of its small section coupled with each other and thereby makes the structure even more flexible, easily bendable and easy carriable over longer distances. The entire structure over the wheeled flat-bed [102] is enabled to be bent and packed into a small zippered compartment for protecting it when traveling or stored in a garage. The retractable cover [104] is also provided with plurality of the first coupling member [106] which is coupled on all four side at the perimeter of the retractable cover [104]. These plurality of first coupling member [106] is removable-ly attached with the plurality of small opening [not shown] made onto the surface of the retractable cover [104]. These plurality of small opening is present at regular interval onto the retractable cover [104] surface and is enabled to receive plurality of the coupling member [106] into it. These plurality of the first coupling member [106] is enabled to adjust its spacing in accordance to the different spacing and coupling of the plurality of brackets [112] provided onto the wheeled flat-bed [102] of the various utility trailer [100]. If in case the plurality of the brackets [112] present on the wheeled flat-bed [102] is not able to receive the plurality of the first coupling member [106] present onto the surface of the retractable cover [104] the at least one user is also provided with the flexibility to remove the plurality of the first coupling member [106] by simply sliding it to the sides and attach the different shaped or size plurality of the first coupling member [106] which the plurality of the bracket [112] is comfortable to receive without a difficulty.

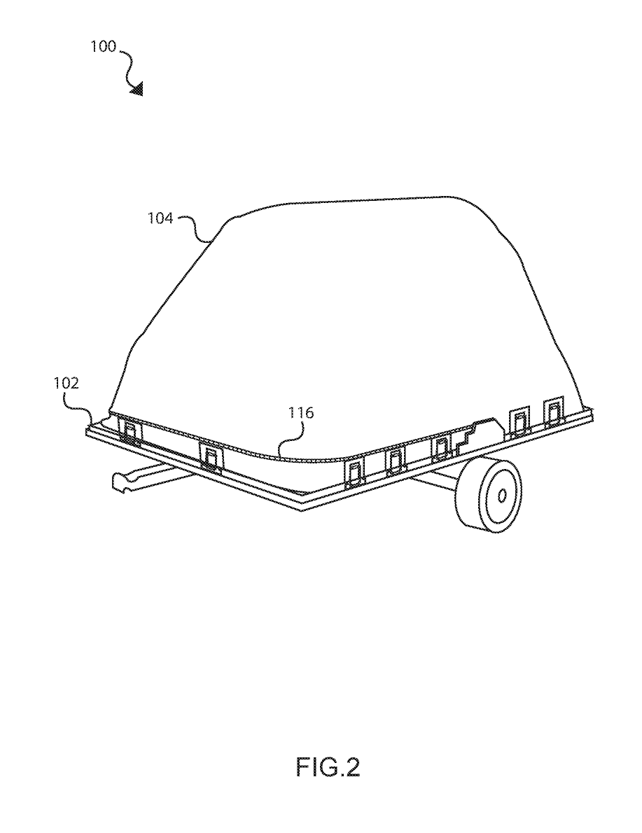

FIG. 2 illustrates the front perspective view of the retractable cover [104] according to an embodiment of the invention. The front perspective view of the invention supports at-least first zipper [116] present on the either side of the retractable cover [104] to enable some portion of the retractable cover [104] to retract back when in unzipped state. The at least first zipper [116] is provided to cover only half portion of the entire surface area of the retractable cover [104], wherein when at least first zipper [116] is let open by the at least one user gives the access to the wheeled flat-bed [102] directly to place any goods or material into the utility trailer [100] without lifting the entire structure supported over the wheeled flat-bed [102] of the utility trailer [100].

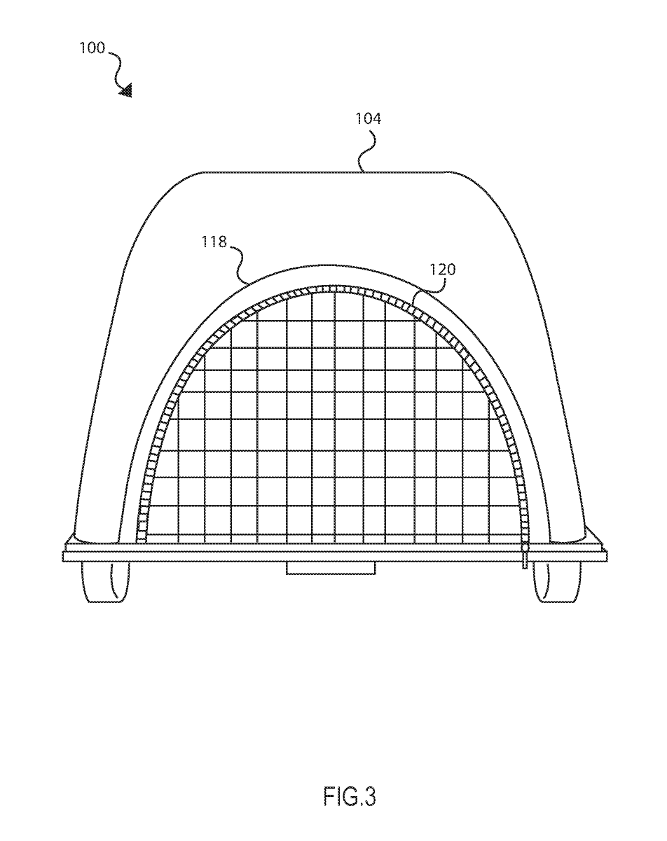

FIG. 3 illustrates the back view of the retractable cover in according to an embodiment of the invention. The invention further supports at-least one opening [118] present on the either side of the retractable cover [104] with at-least second zipper [120] to maintain proper ventilation inside the utility trailer [102]. On the back side, there exist the at least one opening [118] with at least second zipper [120], wherein at least one opening [118] provides a window and air flow inside the retractable cover [104] and further provides the easy access to the various items stored under the retractable cover [104] when the door is opened, without having to remove the retractable cover [104]. It also provides access and air flow in the interior when using the retractable cover [104] and utility trailer [100] as shelter or a tent when hunting and camping.

In a preferred embodiment of the present invention, the at least one user is first having to check the shape and size of the wheeled flat-bed [102] onto which the retractable cover [104] is to be attached. Once, the checking process is done and the at least one user gets the idea of which plurality of first coupling member [106] is to be attached to the small openings of the retractable cover [104] so that the plurality of the bracket present onto the wheeled flat-bed [102] of the utility trailer [100] can easily receive the plurality of the coupling member [106] without a difficulty. The retractable cover [104] then is made to slide over the plurality of the rods [110] removably coupled to the central hinge [114] and further get attached to the plurality of the rods [110] with the help of the plurality of the loops [108] present onto the inner surface [104a] of the retractable cover [104]. To place any goods or material inside the retractable cover [104] at least first zipper [116] is provided to cover only ½ portion of the entire surface area of the retractable cover [104] without lifting the entire structure supported over the wheeled flat-bed [102] of the utility trailer [100]. Also, on the back side, there exist the at least one opening [118] with the at least second zipper [120], wherein at least one opening [118] provides a window and air flow inside the retractable cover [104] and further provides the easy access to the various items stored under the retractable cover [104] when the door is opened, without having to remove the retractable cover [104].

What is claimed is:

1. A retractable cover coupled to a wheeled flat bed of the utility trailer comprises:
a) a plurality of first coupling member, coupled to a perimeter of the retractable cover to provide coupling of the retractable cover with the wheeled flat-bed;
b) a plurality of second coupling member present on an inner surface of the retractable cover, enables the retractable cover to slide over a plurality of the rods, coupled to the wheeled flat bed for and further secure the retractable cover over the plurality of rods;
c) at-least first zipper present on the either side of the retractable cover to enable some portion of the retractable cover to retract back when in unzipped state; and
d) at-least one opening present on the either side of the retractable cover with at-least second zipper to maintain proper ventilation inside the utility trailer.

2. The retractable cover in claim 1, wherein the retractable cover is made up of highly flexible material like plastic, PVC polymer, thermoplastic, fiber or the combination thereof.

3. The retractable cover in claim 1, wherein the plurality of the rods is made up of small section, wherein the small section is enables the plurality of the rods to be bent from any of its small section and thereby makes the structure even more flexible, easily bendable and easy carriable over longer distances

4. The retractable cover in claim 1, wherein the entire structure over the wheeled flat-bed is enabled to be bent and packed into a small zippered compartment for protecting the retractable cover along with the plurality of the rods when traveling or stored in a garage.

5. The retractable cover in claim 1, wherein the plurality of the coupling member is removably attached with a plurality of small opening made onto the surface of the retractable cover.
